(19) United States
(12) Patent Application Publication
(10) Pub. No.: US 2007/0248092 A1
(43) Pub. Date: Oct. 25, 2007

(54) System and method for efficient traffic distribution in a network

(75) Inventor: Takahito Yoshizawa, Cary, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/409,910

(22) Filed: Apr. 24, 2006

(51) Int. Cl. H04L 12/56

(52) U.S. Cl. 370/392; 370/238

(57) ABSTRACT

A plurality of data messages is received. Each of the data messages has an associated source address and a destination address. A data link is selected to transfer each of the data messages based upon the source address and destination address of the data message. The data link is selected from amongst a plurality of data links. The selecting purposefully causes a substantially uniform distribution of the plurality of data messages to be made across the plurality of data links with respect to a given period of time.

### FIELD OF THE INVENTION

The field of the invention relates to communications in networks and, more specifically, to distributing traffic over multiple channels in a network.

### BACKGROUND OF THE INVENTION

Modern communication systems provide different elements that communicate with each other over communication links. Sometimes these links are aggregated together into groups, for instance, into Link Aggregation Groups (LAGs) as defined by the IEEE 802.3 standard (IEEE Std. 802.3-2002, Clause 43). The physical and link-layer operations associated with these links have also been standardized in many cases. For instance, the IEEE 802.3 standard includes a Link Aggregation Control Protocol (LACP) that defines the negotiation and management procedures to be used for LAGs. While providing some guidance for a few procedures used in these systems, such standards do not address many other technical issues. For instance, IEEE 802.3 and other standards do not specify any approach for choosing a particular link from the aggregation of links in order to distribute traffic evenly or predictably across the link aggregation.

Because of the absence of a standard approach of distributing traffic, various disparate approaches have been developed to distribute traffic amongst the links of a network. For example, some of these previous traffic distribution algorithms obtained the source and destination address of a communication (e.g., the three bits from the Least Significant Byte (LSB) of the source and destination addresses), performed an exclusive OR operation on the bits, and determined a link identifier from the results of the exclusive OR operation. The communication was then placed upon the link associated with the identifier and transmitted.

Unfortunately, using three bits of the LSB resulted in a balanced distribution of traffic over multiple links only when the number of links in a LAG was a power of 2 (e.g., 2, 4, or 8). Consequently, uneven traffic distributions were frequently produced. Because of this uneven distribution of traffic, the effective capacity of the system was much lower than was theoretically possible. Reduction of the capacity of the system resulted in slower communications between users, dropped communications, and increased user frustration with the system.

### BRIEF DESCRIPTION OF THE DRAWINGS

FIG. 1 is a block diagram of a system for allocating links according to embodiments of the present invention;

FIG. 2 is a flowchart of an approach for allocating links according to embodiments of the present invention;

FIG. 3 is a block diagram of a device for allocating links according to embodiments of the present invention;

FIG. 4 is a table showing link distribution according to embodiments of the present invention; and

FIG. 5 is a table showing link distribution according to embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

A system and method for distributing traffic across links of a network assures a substantially even distribution of traffic across these links. By assuring the substantially even distribution of traffic across the links, system performance is enhanced as is the user experience with the system.

In many of these embodiments, a plurality of data messages is received in an Ethernet system. Each of the data messages has an associated source address and a destination address. A data link is selected to transfer each of the data messages based upon the source address and destination address of the data message. The data link is selected from amongst a plurality of data links. The selecting purposefully causes a substantially uniform distribution of the plurality of data messages to be made across the plurality of data links with respect to a given period of time.

Various approaches may be used to identify the actual data link to ensure that the distribution of traffic across the links is substantially uniform. For instance, in one example, the identity of a particular data link may be determined by a hashing function such as:
data link=Mod((Sum(a, b)), n)+1), where a is the source address; b is the destination address; and n is a number of data links.

Although many different hashing functions may be used, preferably, the hashing function does not utilize an exclusive OR (XOR) operation. Additionally, various portions of the source and destination addresses may be used in the operation. In one example, three bits from the source and destination addresses are used. In other approaches, other numbers of bits may be utilized.

Thus, a system and method of distributing traffic substantially evenly across the links of a link aggregation are provided. By assuring the even distribution of traffic across the aggregation of data links, system performance is enhanced as is the user experience with the system.

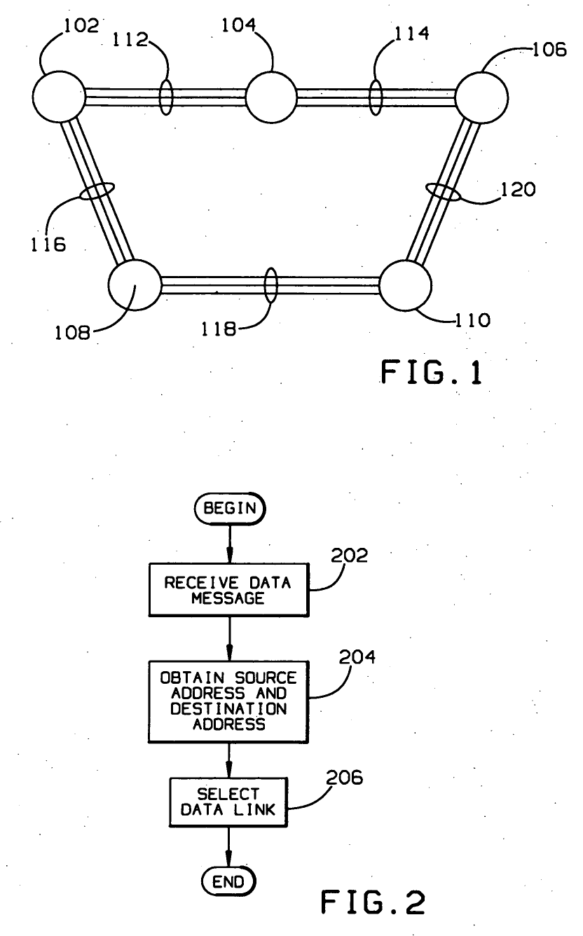

Referring now to FIG. 1, one example of a system for distributing traffic evenly across an aggregation of data links is described. A network 100 includes a plurality of nodes 102, 104, 106, 108, and 110. The nodes 102, 104, 106, 108, and 110 may be any type of device that is used within a network. For instance, the nodes 102, 104, 106, 108, and 110 may be switches, gateways, servers, base stations, or mobile stations. If the nodes are mobile stations, the nodes may be cellular telephones, personal computers, personal digital assistants (PDAs), or personal computers. Other examples of nodes and mobile stations are possible. In addition, the particular architecture of the network shown in FIG. 1 is only one example of one possible network structure. Other architectures and connections are possible. By one approach, the system of FIG. 1 is an Ethernet or Ethernet-like system. However, other types of systems or networks may also be used.

The nodes 102, 104, 106, 108, and 110 communicate with each other over data links 112, 114, 116, 118, and 120. Each of these connections may be aggregations of links and may include one or more links. The nodes 102, 104, 106, 108, and 110 each include a controller or similar functionality that chooses a link from the aggregation of one or more links in order to transmit data.

In one example of the operation of the system of FIG. 1, a plurality of data messages is received at a node 102, 104, 106, 108, or 110 in the Ethernet system. Each of the data messages has an associated source address and a destination address. A data link is selected to transfer each of the data messages based upon the source address and destination address of the data message. The data link is selected from amongst a plurality of data links. The selecting purposefully causes a substantially uniform distribution of the plurality of data messages to be made across the plurality of data links with respect to a given period of time.

Various approaches may be used to identify the actual data link to ensure that the distribution of traffic across the links is substantially uniform. For instance, in one example the identity of a particular data link may be determined by a hashing function such as:
data link=Mod((Sum(a, b)), n)+1), where a is the source address; b is the destination address; and n is a number of data links.

By one approach, XOR operations are not used in the determination of the data link identity. In addition, it will be realized that the formula used above may be varied or changed and that other calculations may be used.

Referring now to FIG. 2, one example of an approach for choosing a data link from a aggregation of data links to send a message is described. At step 202, a data message is received. For example, the data message may be received at any node in an Ethernet network and the message may include both source and destination addresses.

At step 204, the source and destination addresses are obtained from the message. Alternatively, other types of identifiers or other types of information in the data message may be extracted for later use in the link calculation. For instance, information such as the Layer 3 (Network Layer) protocol type, or Layer 4 (Transport Layer) TCP/UDP port number may also be used.

At step 206, a data link is selected. Any suitable algorithm may be used, for example, the formula described above with respect to FIG. 1. Again, by one approach, the algorithm or formula does not make use of the XOR operation.

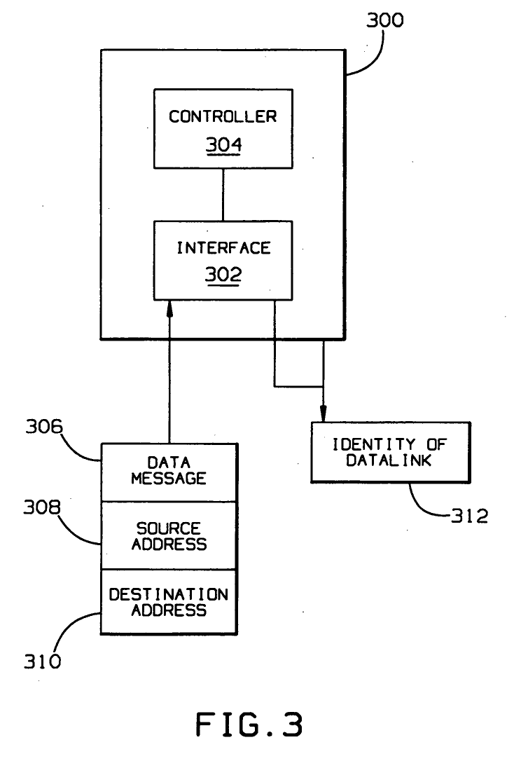

Referring now to FIG. 3, one example of a device 300 for distributing the link assignment includes an interface 302 and a controller 304. The interface receives a data message 306 having a source address 308 and a destination address 310. The controller 304 is programmed to determine an identity of data link 312 from amongst a plurality of data links using the source and destination address 308 and 310. Alternatively, other information may be used. The controller 304 is further programmed to select the data link 312 from the plurality of data links such that a substantially uniform distribution of the plurality of data messages is purposefully obtained across the plurality of data links.

The controller 304 may determine the plurality of data links is selected according to:
data link=Mod((Sum(a, b)), n)+1) where a is the source address; b is the destination address; and n is a number of data links.

As mentioned above, by one approach, XOR operations are not used in the determination of the data link identity. In addition, it will be realized that the formula used above may be varied and that other calculations may be used.

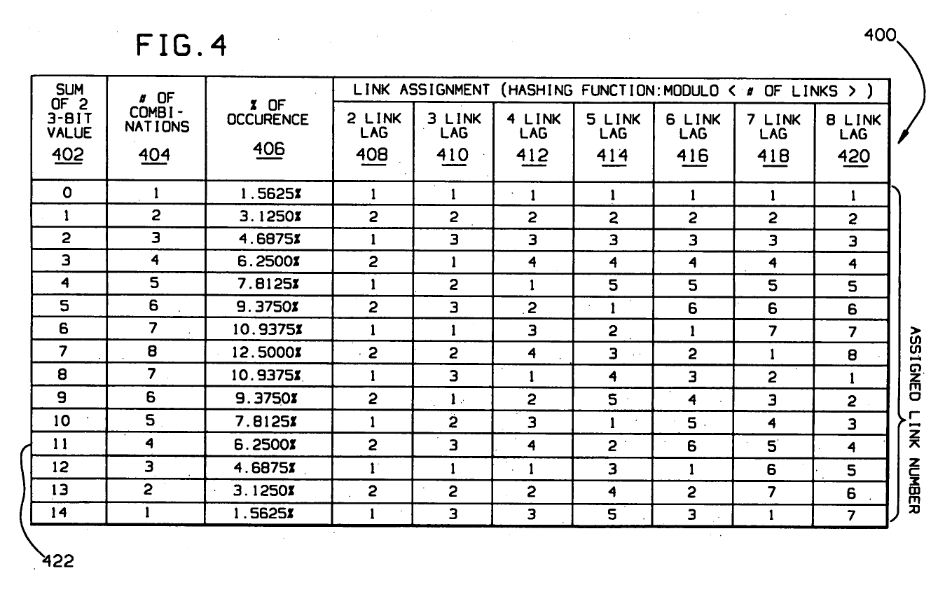

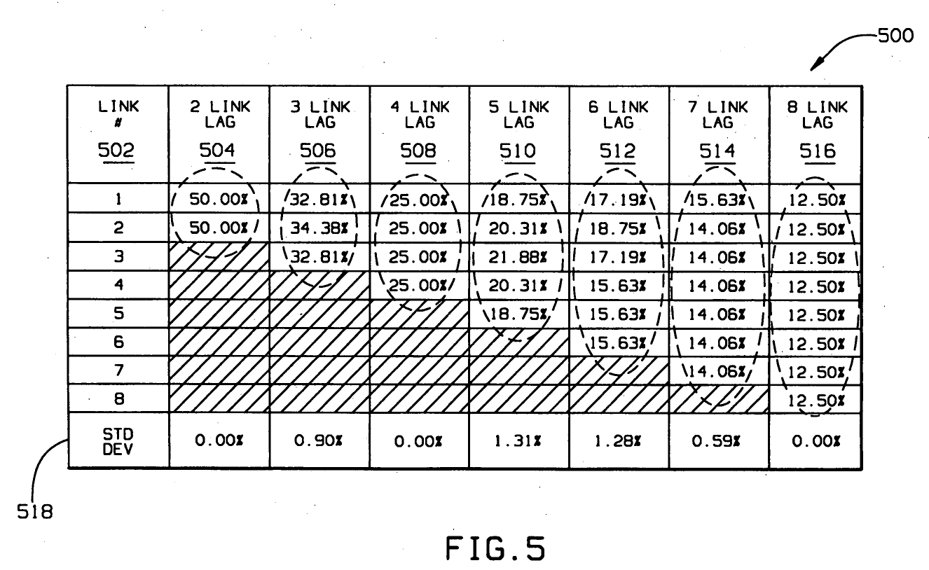

Referring now to FIG. 4, an example of applying the approaches described herein is described. A table 400 assumes three-bit source and destination addresses are used and the formula given above with respect to FIG. 1 is used to determine the link identity. A first column 402 in the table 400 shows possible sums of the source and destination addresses. These sums range from 0 to 14. Thus, for source an destination addresses of length m (e.g., 3), an intermediate link identifier of length m+1 (e.g., 4) is produced.

A second column 404 in the table 400 represents the number of possible combinations of addresses that can be used to arrive at the sums of column 402. A third column 406 in the table 400 represents the percentage of the number of combinations. The remaining columns 408, 410, 412, 414, 416, 418, and 420 of the table 400 show the assigned link number using the above-mentioned equation for, respectively, 2, 3, 4, 5, 6, 7, and 8 element link aggregations.

In one example, it can be seen in a row 422 that the sum of 11 (for the address values) is produced 6.25 percent of the time with four possible combinations. Using the formula described previously, link number 2 is chosen in a 2 link LAG; link number 3 is chosen in a 3 link LAG; link number 4 is chosen in a 4 link LAG; link number 2 is chosen in a 5 link LAG; link number 6 is chosen in a 6 link LAG; link number 5 is chosen in a 7 link LAG; and link number 4 is chosen in an 8 link LAG.

Referring now to FIG. 5, another example of applying these approaches is shown in a table 500. In the table 500, the values shown in the columns 408-420 of the table 400 are correlated. Specifically, a column 502 shows the link number. The columns 504, 506, 508, 510, 512, 514, and 516 of the table 500 show the percentage of time a particular link number is chosen for a system having a given number of links.

To take one example, it can be seen that in a two link LAG, link number 1 is selected 50 percent of the time and link number 2 is selected 50 percent of the time using the approaches described herein. In another example, it can be seen in a three link LAG, link number 1 is selected 32.81 percent of the time, link number 2 is selected 34.38 percent of the time, and link number 3 is selected 32.81 percent of the time. A standard deviation row 518 shows that the standard deviation for link selection is 1.31 percent or lower.

Thus, a system and method of distributing traffic across links of a network assures a substantially even distribution of traffic across these links are provided. By assuring the even distribution of traffic across the links, system performance is enhanced as is the user experience with the system.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of distributing traffic across a plurality of links comprising:
receiving a plurality of data messages, each of the data messages having an associated source address and a destination address; and
selecting a data link to transfer each of the data messages based upon the source address and destination address of the data message, the data link being selected from amongst a plurality of data links, the selecting purposefully causing a substantially uniform distribution of the plurality of data messages to be made across the plurality of data links with respect to a given period of time.

2. The method of claim 1 wherein the selecting of the data link is made according to:
data link=Mod((Sum(a, b)), n)+1) where
a is the source address; b is the destination address; and n is a number of data links.

3. The method of claim 1 wherein selecting the data link comprises selecting the data link based upon a sum of the source address and the destination address.

4. The method of claim 1 wherein the source and destination addresses have a length of m and wherein the selecting produces an intermediate link identifier having a length of m+1.

5. The method of claim 1 wherein the selecting uses a hashing function and the hashing function does not utilize an exclusive or (XOR) operation.

6. A method of distributing traffic substantially evenly across a plurality of data links of a network comprising:
receiving a plurality of data messages, each of the data messages having a source identifier and a destination identifier;
choosing a hashing function;
applying the source identifier and the destination identifier of each of the plurality of data messages to the hashing function, the hashing function selecting a data link from amongst a plurality of data links such that a distribution of the plurality of data messages across the plurality of data links is substantially uniform, to thereby provide at least one selected data link; and
transmitting each of the data messages using the at least one selected data link.

7. The method of claim 6 wherein the hashing function comprises:
data link=Mod((Sum(a, b)), n)+1) where
a is a source address; b is a destination address; and n is a number of data links.

8. The method of claim 6 wherein selecting the data link comprises selecting the data link based upon a sum of the source address and the destination address.

9. The method of claim 6 wherein the source and destination identifiers have a length m and wherein the determining produces an intermediate link identifier having a length of m+1.

10. A system for distributing traffic across links comprising:
an interface having an input to receive a plurality of data messages each having a source address and a destination address; and
a controller coupled to the interface, the controller being programmed to determine a data link from amongst a plurality of data links using the source and destination address, the controller being further programmed to select a data link from the plurality of data links such that a substantially uniform distribution of the plurality of data messages is purposefully obtained across the plurality of data links.

11. The system of claim 10 wherein each of the plurality of data links is selected according to:
data link=Mod((Sum(a, b)), n)+1) where
a is the source address; b is the destination address; and n is a number of data links.

12. The system of claim 10 wherein the controller selects the data link by at least in part computing a sum of the source address and the destination address.

13. The system of claim 10 wherein the source and destination addresses have a length m and wherein an intermediate link identifier having a length of m+1 is created when determining the data link.

14. The system of claim 10 wherein the controller is programmed to use a hashing function and the hashing function does not utilize an exclusive or (XOR) operation.
